(19) United States
(12) Patent Application Publication
(10) Pub. No.: US 2025/0111660 A1
(43) Pub. Date: Apr. 3, 2025

(54) SYSTEMS AND METHODS FOR MULTI WINDOW TRAINING OF VISION MODELS

(71) Applicant: NAVER CORPORATION, Gyeonggi-do (KR)

(72) Inventors: Vincent LEROY, Laval (FR); Philippe Weinzaepfel, Montbonnot-Saint-Martin (FR); Thomas Lucas, Grenoble (FR); Jèrome Revaud, Meylan (FR)

(73) Assignee: NAVER CORPORATION, Gyeonggi-do (KR)

(21) Appl. No.: 18/798,032

(22) Filed: Aug. 8, 2024

Related U.S. Application Data
(60) Provisional application No. 63/541,026, filed on Sep. 28, 2023.

(51) Int. Cl. G06V 10/82; G06V 10/771; G06V 10/776

(52) U.S. Cl. CPC G06V 10/82; G06V 10/771; G06V 10/776

(57) ABSTRACT

A training system includes: a transformer module having the transformer architecture and configured to perform a vision task; and a training module configured to: receive a training image having a predetermined resolution; determine N windows of tokens of pixels in the training image and mask the tokens of all of the other pixels of the training image that are outside of the N windows, where N is an integer greater than or equal to 2; input the N windows of tokens to the transformer module; train the transformer module based on an output of the transformer module generated based on the N windows of tokens; and test the transformer module using a test image having the predetermined resolution.

### CROSS-REFERENCE TO RELATED APPLICATIONS

This application claims the benefit of U.S. Provisional Application No. 63/541,026, filed on Sep. 28, 2023. The entire disclosure of the application referenced above is incorporated herein by reference.

### FIELD

The present disclosure relates to semantic image segmentation models and more particularly to systems and methods for training high resolution visual models, such as visual transformers.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are one type of robot and are an example of an autonomous system that is mobile and may be trained to navigate environments without colliding with objects during travel. Navigating robots may be trained in the environment in which they will operate or trained to operate regardless of environment.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants/humans from a pickup to a destination. Another example of a navigating robot is a robot used to perform one or more functions inside a residential space (e.g., a home).

Other types of robots are also available, such as residential robots configured to perform various domestic tasks, such as putting liquid in a cup, filling a coffee machine, etc.

### SUMMARY

In a feature, a training system includes: a transformer module having the transformer architecture and configured to perform a vision task; and a training module configured to: receive a training image having a predetermined resolution; determine N windows of tokens of pixels in the training image and mask the tokens of all of the other pixels of the training image that are outside of the N windows, where N is an integer greater than or equal to 2; input the N windows of tokens to the transformer module; train the transformer module based on an output of the transformer module generated based on the N windows of tokens; and test the transformer module using a test image having the predetermined resolution.

In further features, the N windows are each a rectangle of pixels.

In further features, a first one of the N windows is oriented in a landscape orientation and a second one of the N windows is oriented in a portrait orientation.

In further features, the N windows are each a square of pixels.

In further features, the N windows are each the same size.

In further features, the N windows do not overlap.

In further features, at least a part of a first edge of a first one of the N windows abuts at least a part of a second edge of a second one of the N windows.

In further features, a first total number of pixels within the N windows is 5-50 percent of a second total number of pixels of the training image.

In further features, the training module is configured to determine locations for the N windows randomly.

In further features, the training module is further configured to: receive a second training image having the predetermined resolution; determine N second windows of tokens of pixels in the second training image and mask the tokens of all of the other pixels of the second training image that are outside of the N second windows; input the second N windows of tokens to the transformer module; and train the transformer module further based on a second output of the transformer module generated based on the N second windows of tokens.

In further features, first locations of the N windows are different than second locations of the N second windows.

In further features, the training module is configured to input the N windows to the transformer module with positional embeddings.

In further features, the positional embeddings are relative positional embeddings.

In further features, the vision task is one of a monocular vision task and a multiple-view vision task.

In a feature, a training system includes: a transformer module having the transformer architecture and configured to perform a vision task; and a training module configured to: receive first and second training images having a predetermined resolution; determine N windows of tokens of pixels in the first training image and mask tokens of all of the other pixels of the first training image that are outside of the N windows, where N is an integer greater than or equal to 2; determine M windows of tokens of pixels in the second training image and mask tokens of all of the other pixels of the second training image that are outside of the M windows, where M is an integer greater than or equal to 2; input the N windows and the M windows to the transformer module; train the transformer module based on an output of the transformer module generated based on the N windows and the M windows; and test the transformer module using a pair of test images having the predetermined resolution.

In further features, M is greater than N.

In further features, the training module is configured to determine locations for the M windows based on locations of the N windows.

In further features, the first and second training images each include at least a portion of a same item.

In further features, the first and second training images are one of: captured by first and second cameras, respectively, at approximately the same time; and two frames of video captured by one camera at different times.

In further features, the training module is configured to select the second locations of the M second windows based on noisy optical flow.

In further features, the training module is configured to select the second locations of the M second windows using a greedy algorithm.

In further features, the training module is configured to displace the second locations of the M second windows in the second training image based on a noisy flow value.

In further features, M is greater than N to randomly act as distractors or account for multiple possible flow directions inside a single window.

In further features, the N windows are configured to reduce an effective overall resolution of the training image during training without compromising actual resolution of the training image.

In a feature, a system includes: a camera configured to record images; a semantic segmentation module configured to segment objects in the images recorded by the camera; at least one of (a) a propulsion device configured to move an object and (b) an actuator configured to actuate an object; and a control module configured to, based on one or more of images recorded by the camera including the objects segmented in the one or more images segmented by the semantic segmentation module, control the at least one of the (a) propulsion device and (b) the actuator, where the semantic segmentation module includes a transformer module having the transformer architecture and configured to perform a vision task; and where the transformer module is trained by a training module configured to: receive a training image having a predetermined resolution; determine N windows of tokens of pixels in the training image and mask the tokens of all of the other pixels of the training image that are outside of the N windows, where N is an integer greater than or equal to 2; input the N windows of tokens to the transformer module; train the transformer module based on an output of the transformer module generated based on the N windows of tokens; and test the transformer module using a test image having the predetermined resolution.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIGS. 1 and 2 are functional block diagrams of example robots;

FIG. 3 includes a functional block diagram of an example training system;

FIG. 4 is a functional block diagram of an example implementation of a transformer module;

FIG. 5 includes an example illustration of the processing of two images of a pair and a first image with two windows and a second image with three windows; and

FIG. 6 is a flowchart depicting an example method of training and testing the transformer module.

In the drawings, reference numbers may be reused to identify similar and/or identical elements.

### DETAILED DESCRIPTION

A robot may include a camera. Images from the camera and measurements from other sensors of the robot can be used to control actuation of the robot, such as propulsion, actuation of one or more arms, and/or actuation of a gripper.

Some types of robots may determine a segmentation mask of an object in an image and its class (name) using a vision model, such as a semantic image segmentation (SIS) model. Vision models may include one or more models including the transformer architecture, hereafter referred to as transformer models. Training transformer models for high-resolution tasks may have a prohibitive cost. Training may therefore be performed using low-resolution crops of higher resolution images. Performance may drop however when testing such trained transformer models when testing using images of higher resolutions than those of the crops used for training.

The present application involves training transformer models using a N-window scheme for efficiently training high-resolution transformer models for vision tasks where N is an integer greater than or equal to 2. These architectures receive tokens, which may be defined as clusters of image pixels. The scheme involves the training module masking out a majority of the tokens of high-resolution training images and only training the transformer model using the tokens of N rectangular crops during the training. This allows the transformer model to learn both local token interaction inside each rectangle, and global token interactions when considering the tokens from other rectangles. At test time, the model can directly and more accurately process the high-resolution input. Examples of vision tasks include semantic image segmentation, optical flow, and other vision tasks.

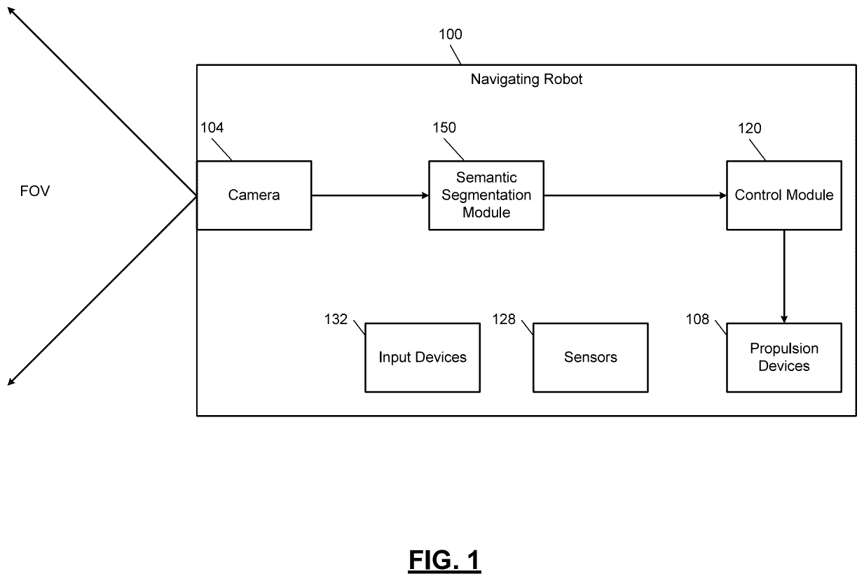

FIG. 1 is a functional block diagram of an example implementation of a navigating robot 100. The navigating robot 100 is a vehicle and is mobile. The navigating robot 100 includes a camera 104 that captures images within a predetermined field of view (FOV). The predetermined FOV may be less than or equal to 360 degrees around the navigating robot 100. The operating environment of the navigating robot 100 may be an indoor space (e.g., a building), an outdoor space, or both indoor and outdoor spaces. In various implementations, the camera 104 may be a binocular camera, or two or more cameras may be included in the navigating robot 100.

The camera 104 may be, for example, a grayscale camera, a red, green, blue (RGB) camera, or another suitable type of camera. The camera 104 may or may not capture depth (D) information, such as in the example of a grayscale-D camera or a RGB-D camera. The camera 104 may be fixed to the navigating robot 100 such that the orientation of the camera 104 (and the FOV) relative to the navigating robot 100 remains constant. The camera 104 may update (capture images) at a predetermined frequency, such as 60 hertz (Hz), 120 Hz, or another suitable frequency.

A semantic segmentation module 150 segments objects in the images in the camera. Segmenting objects is different than object detection in that object detection involves identifying boundary boxes around the objects in images. Segmentation involves identifying the pixels that bound an object within an image.

The navigating robot 100 may include one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly. The robot 100 is powered, such as via an internal battery and/or via an external power source, such as wirelessly (e.g., inductively).

While the example of a navigating robot is provided, the present application is also applicable to other types of robots with a camera.

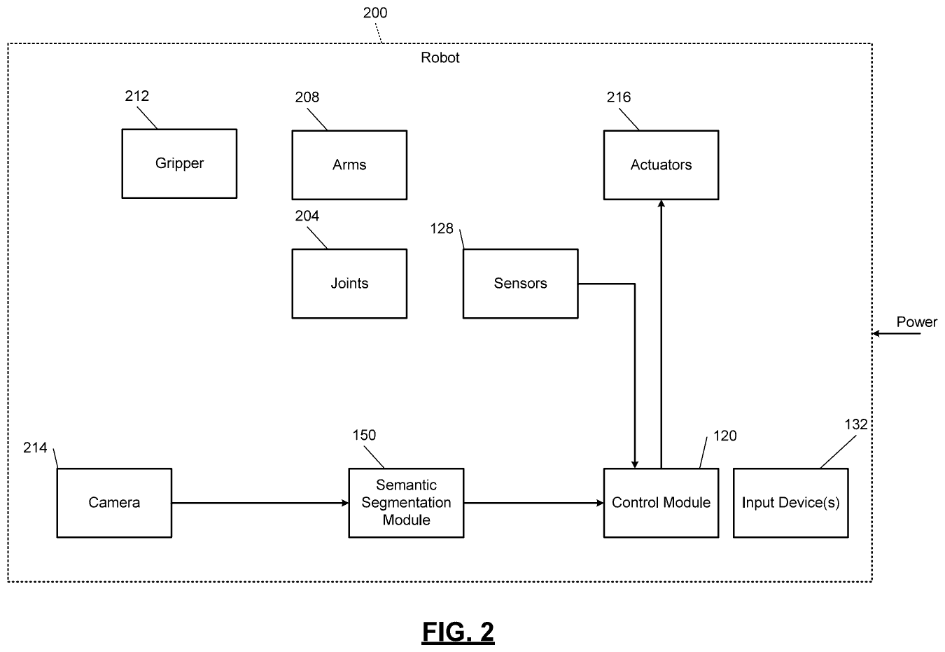

For example, FIG. 2 includes a functional block diagram of an example robot 200. The robot 200 may be stationary or mobile. The robot 200 may be, for example, a 5 degree of freedom (DoF) robot, a 6 DoF robot, a 7 DoF robot, an 8 DoF robot, or have another number of degrees of freedom. In various implementations, the robot 200 may include the Panda Robotic Arm by Franka Emika, the mini Cheetah robot, or another suitable type of robot.

The robot 200 is powered, such as via an internal battery and/or via an external power source, such as alternating current (AC) power. AC power may be received via an outlet, a direct connection, etc. In various implementations, the robot 200 may receive power wirelessly, such as inductively.

The robot 200 includes a plurality of joints 204 and arms 208. Each arm may be connected between two joints. Each joint may introduce a degree of freedom of movement of a (multi fingered) gripper 212 of the robot 200. The robot 200 includes actuators 216 that actuate the arms 208 and the gripper 212. The actuators 216 may include, for example, electric motors and other types of actuation devices.

In the example of FIG. 1, a control module 120 controls actuation of the propulsion devices 108. In the example of FIG. 2, the control module 120 controls the actuators 216 and therefore the actuation (movement, articulation, actuation of the gripper 212, etc.) of the robot 200. The control module 120 may include a planner module configured to plan movement of the robot 200 to perform one or more different tasks. An example of a task includes moving to and grasping and moving an object. The present application, however, is also applicable to other tasks, such as navigating from a first location to a second location while avoiding objects and other tasks. The control module 120 may, for example, control the application of power to the actuators 216 to control actuation and movement. Actuation of the actuators 216, actuation of the gripper 212, and actuation of the propulsion devices 108 will generally be referred to as actuation of the robot.

The robot 200 also includes a camera 214 that captures images within a predetermined field of view (FOV). The predetermined FOV may be less than or equal to 360 degrees around the robot 200. The operating environment of the robot 200 may be an indoor space (e.g., a building), an outdoor space, or both indoor and outdoor spaces.

The camera 214 may be, for example, a grayscale camera, a red, green, blue (RGB) camera, or another suitable type of camera. The camera 214 may or may not capture depth (D) information, such as in the example of a grayscale-D camera or a RGB-D camera. The camera 214 may be fixed to the robot 200 such that the orientation of the camera 214 (and the FOV) relative to the robot 200 remains constant. The camera 214 may update (capture images) at a predetermined frequency, such as 60 hertz (Hz), 120 Hz, or another suitable frequency. In various implementations, the camera 214 may be a binocular camera, or two or more cameras may be included in the robot 200.

The control module 120 controls actuation of the robot based on one or more images from the camera, such as the objects segmented in the images. The control module 120 may control actuation additionally or alternatively based on measurements from one or more sensors 128 and/or one or more input devices 132. Examples of sensors include position sensors, temperature sensors, location sensors, light sensors, rain sensors, force sensors, torque sensors, etc. Examples of input devices include touchscreen displays, joysticks, trackballs, pointer devices (e.g., mouse), keyboards, steering wheels, pedals, and/or one or more other suitable types of input devices.

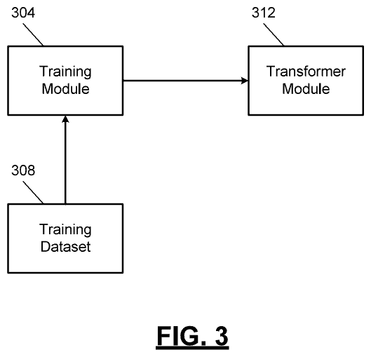

FIG. 3 is a functional block diagram of an example training system. A training module 304 trains a transformer module 312 using a training dataset 308. The transformer module 312 may be, for example, of the semantic segmentation module 150 and used to perform the task of semantic segmentation (or more simply segmentation). While the example of the transformer module 312 performing segmentation is provided, the present application is applicable to training of transformer modules used to perform other vision tasks, such as the binocular task of optical flow and other vision tasks. While the example of binocular tasks is provided, the present application is more generally applicable to multi-view tasks involving two or more images/views. For example, the second image may be replaced with a collection of images. The masking discussed herein may be applied and repeated for all images in the collection. In this case, the process would involve picking N windows in the query image (first) and for each reference image the respective optical flow is used to guide the sampling of M windows for the collection of images. The M windows in that case would be differently placed for each image of the collection. Example use cases include three dimensional (3D) reconstruction and visual localization, such as where the transformer module is a matching network that can be used for both tasks.

The transformer module 312 has a transformer architecture, such as that described in Alexey Dosovitiskiy, et al., An Image is Worth 16×16 Words: Transformers for Image Recognition at Scale, ICLR, 2021, which is incorporated herein in its entirety. Transformer architecture is also described in Ashish Vaswani, at al., Attention is all you need, In I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety. Additional information regarding the transformer architecture can be found in U.S. Pat. No. 10,452,978, which is incorporated herein in its entirety.

Training of the transformer module 312 could involve the use of high-resolution training images which may be cost prohibitive or with lower-resolution crops of high-resolution images. Use of crops though may lead to the transformer module 312 performing poorly at test time based on the resolution difference between the training crops and high-resolution images used during testing.

The multi-window training (WiT) described herein enables efficient training of the transformer module 312 using high-resolution images by sampling N crops per training image at the same time in the input to the transformer module 312. This allows the transformer module 312 to model both local and global interactions. With this training, the transformer module 312 performs well at test time based on high-resolution test images.

The training involves training the transformer module 312 with self-attention based on only on a subset of tokens, which can be considered as or similar to a structured masking augmentation. When revealing only parts of the input tokens, the others can be removed altogether from the inputs of the transformer module 312. This leads to more efficient and less cost prohibitive training using high-resolution training images that reduces the effective overall resolution of images used during training without compromising their actual resolution. The training module 304 may control the visible tokens in a structured way using random windows, which may be different than the masking performed in masked image modeling. This allows the transformer module 312 to model local information, which may be important for dense prediction tasks and other vision tasks. At the same time, global interactions are learned as well. To combine local and global information, the training module 304 may randomly select multiple windows in each input training image, so global interactions can be learned by the transformer module 312 when considering tokens from different windows. In various implementations, rectangular windows may be used, which lends itself to the convolutional heads typical to dense tasks with transformer backbones. For monocular vision tasks, two square windows of the same shape may be used and may perform similarly to more elaborate shapes and/or sizes of windows.

Dense tasks such as semantic image segmentation may be translation equivariant, which can thus be useful during designing deep models. Absolute positional embeddings that are added to the signal by the transformer module 312, either learned or using cosine functions, do not satisfy this property.

The transformer module 312 may therefore add relative positional embeddings, such as directly at the level of self-attention computations. The relative positional embeddings may be learned constants (e.g., outputs of a neural network) or given by transforms only applied to queries and keys. Discussed further below includes the latter, which may not involve learnable parameters. This may lead to increased performance of the transformer module 312 during testing relative to the use of absolute positional embeddings. While the training discussed herein allows for testing directly at the target resolution of the same resolution as the training images, statistics of the self-attention mechanisms (modules) of the transformer module 312 may change when more tokens become visible at test time. This may be compensated for by the transformer module 312 using a temperature factor in the softmax of the attention, which can be validated using the performance on the full-resolution training images. The chosen temperatures may approximately correspond to the temperature that preserves the self-probability in the attention, when assuming a uniform distribution of the attention across tokens before the relative positional embeddings are applied.

The high cost of the training may be at least partially due to the quadratic complexity of the global attention mechanism of the transformer module 312 with respect to the number of input tokens. The transformer module 312 could be trained using lower resolution crops and tested using higher resolution images or fixed scaling could be used during both training and testing. As discussed above, however, these trainings may result in decreased performance. The training described herein involves training the transformer module 312 from a subset of tokens, and thus to keep the original global attention in all blocks.

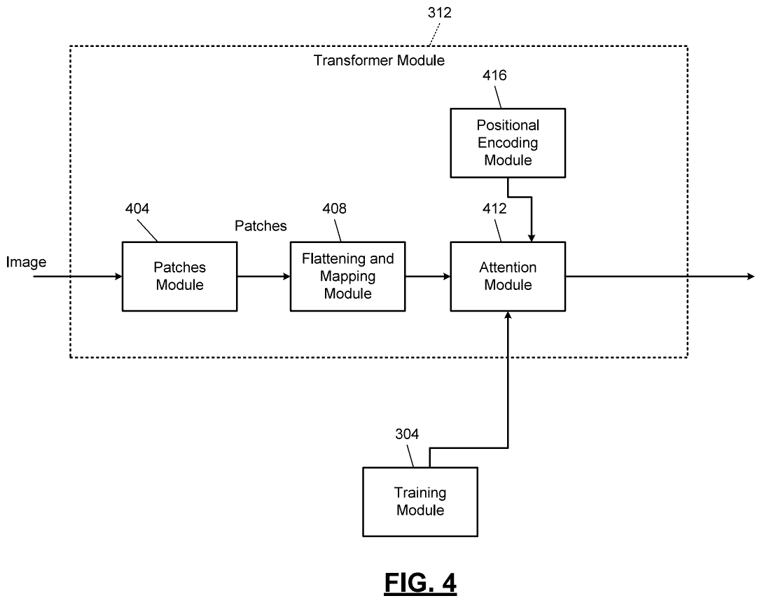

FIG. 4 is a functional block diagram of an example implementation of the transformer module 312. The transformer module 312 includes a patches module 404 that divides an input image x∈ [symbol] ^{H×W×C}, with H, W, C, being height, width, and channels, into a set of patches of resolution (P, P), denoted Pₓ={x_{i,j}∈ [symbol] ^{P}^{²}^{·C}}_{i,j∈I×J}, with (H,W) corresponding to the resolution of the input image, I={1, . . . , └H P┘}, J={1, . . . , └W P┘} and C the number of channels. A flattening and mapping module 408 flattens and maps the patches to D dimensional embeddings using a trainable linear projection, resulting in a set of I×J tokens in [symbol] ^{D}.

For the multi-window training, the training module 304 selects a subset of the those patches. Let ω be a rectangle with integer coordinates in I×J, identified by the two dimensional (2D) origin of the leftmost point of the rectangle, width and height: ω=(x, y, h, w) with (x, y)∈I×J and (h,w)∈{1, . . . , max (1, I−x)}×{1, . . . , max (1, J−y)}. These rectangles are the windows.

For the multi-window training, the training module 304 selects (e.g., randomly) N windows, ω₁ . . . ω_{N} from the input training image (each training image), and process only the subset of Px in the union of those windows:

$${P}_{x}^{ω} = \{ {x}_{i , j} \vert ∃ k \vert {x}_{k} \leq i \leq {x}_{k} + {h}_{k} , {h}_{k} , {y}_{k} \leq j \leq {y}_{k} + {w}_{k} \} \qquad ( 1 )$$

An attention (self attention) module 412 processes the subset of the windows selected by the training module 304. At each layer, the attention module 412 projects all input tokens into |Pₓ^{w}| queries and keys, both of dimension dₖ and denoted Q and K, and |Pₓ^{w}| values of dimension dv and denoted V. The dot products of each query is computed by the attention module 412 with each key, divided by √dk, and normalized by the attention module 412 using a softmax function to generate attention scores. The attention module 412 determines the dot product between these scores and the values are in parallel for all queries:

$$attention ( Q , K , V ) = softmax ( \frac{{QK}^{T}}{√ dk} ) V .$$

This results in the attention module 412 generating 4·|Pₓ^{w}|+|Pₓ^{w}|²=σ((Σₖ₌₁^{N}hₖxwₖ)²) features for each attention layer of the attention module 412. Without the selection of windows, the transformer module 312 would compute a number of features scaling in |P|²=σ((H×W)²). With the selection of window for the training described herein, however, the number of features determined is independent of H and W of the input image, but is instead dependent upon the size of the windows. For a given budget (e.g., number of tokens) at training time, the training module 304 may set the windows height and width or the height and width may be predetermined values, such as set based on user input.

At test time (after training of the transformer module 312 based on the windows of the training images), the windows are not used and the full image is processed by the transformer module 312. Because the transformer module 312 has seen both short-range and long-range interactions between tokens during the training, coming either from within each window or across different windows, the transformer module 312 can generalize to fully visible images at test time. This is different than training from a single random crop of lower resolution than the higher resolution training image from which the crop is taken.

The transformer module 312 includes a composition of functions that are equivariant to permutation of their inputs. Therefore, to preserve information about spatial structure, positional information is added to the features by a positional encoding module 416, which increases performance of the transformer module 312 after the training. This may be due to a form of translation equivariance in optimization resulting from the use of windows.

Regarding the translation equivariance, let x be input image, ω={ωk}k a set of windows, and s=(sₓ,s_{y}) be a spatial shift with integer coordinates that does not push any window in {ωk} outside of the full resolution image. Applying such a shift s to x and all windows does not change the input information of the network:

$$( {s}_{x} , {s}_{y} ) : \{ \begin{matrix}- {min}_{k} ( {x}_{k} ) \leq {s}_{x} \leq {min}_{k} ( H - {x}_{h} + h ) \\ - {min}_{k} ( {y}_{k} ) \leq {s}_{y} \leq {min}_{k} ( W - {y}_{k} + {w}_{k} )\end{matrix} ⇒ {P}_{s ( x )}^{w + s} = {P}_{x}^{w} \qquad ( 2 )$$

The input patches are the same, so the change of spatial coordinate can modify the model output through positional encodings. This is in contrast with input images for which any shift modifies the observed content. Making the transformer module 312 translation equivariant by design simplifies the multi-window training compared to having to learn this equivariance from training data. Thus the training is such that for s verifying Equation 2:

$$WiT ( s ( x ) , w + s ) = s ( WiT ( x , w ) ) . \qquad ( 3 )$$

In various implementations, the positional encoding module 416 injects the positional encodings (positional information) in the embedded input tokens with a learnable vector per spatial position or cosine embeddings. These may be considered absolute positional embeddings as they modify a feature vector f depending on it's absolute two dimensional (2D) position: abspos(f)=f+embed(x_{f},y_{f}). Absolute embeddings may not be translation invariant.

Relative positional encodings may be translation invariant. Relative positional encodings may be embeddings of the relative position between two features h and g used as additional input to a function computed from h and g: frelpos=f(h,g,embed(x_{g}−xₕ,y_{g}−yₕ)).

For vision tasks, translation equivariance may be a desirable property. Relative positional information to help for a variety of tasks. For example, the positional encoding module 416 may inject Rotary Positional Embeddings (RoPE), described in Jianlin Su, et al, Roformer: Enhanced Transformer with Rotary Position Embedding; arXiv preprint arXiv: 2104.09864, 2021, which is incorporated herein in its entirety. Relative positional encodings/embeddings are translation equivariant.

Relative positional embeddings may be significantly beneficial in the context of the training described herein.

For monocular vision tasks, the training described herein decouples the number of features computed during training from the resolution H×W but may affect the ability of the transformer module 312 to generalize at test time. This may depend on the distribution of windows (N): N being set to cover the full images becomes training at the target high resolution. N being zero provides no training.

Regarding window distribution, the number of features computed respects the budget. This may be controlled by the number of tokens, the number of input tokens in P ω—with some variance due to rounding window areas to integer coordinates. All input patches are frequently made visible during training, controlled by N the number of windows, their positions p={p₁, . . . p_{N}}, and their aspect ratio r={r₁, . . . r_{N}}. N may be a fixed predetermined value or may be variable, such as a random value. Randomizing the aspect ratios r may perform similarly to using square windows of the same size. The positions p may be varied in various implementations, such as randomized. N is an integer greater than or equal to 2 to account for both global and local token interactions and to train the transformer module 312 to generalize well at test time.

In various implementations, rectangular windows may be used at training time for performance.

Regarding feature distribution changes, unmasking the full image at test time induces changes in the number of input tokens. Although self-attention works with an arbitrary number of inputs, the softmax distribution can be altered by this increase. To compensate for this, a temperature hyper-parameter in the softmax may be used:

$$attention τ ( Q , K , V ) = softmax ( \frac{τ {QK}^{T}}{\sqrt{dk}} ) V .$$

The training module 304 may train the hyper-parameter after training, such as using full target (test) resolution images, i.e. without windows. In various implementations, the training module 304 may set t using the average expected self-probability in the attention blocks, when increasing the number of tokens from the subset used for training to that of test time.

For some tasks like optical flow, the training module 304 may train the transformer module 312 on multiple sources of training data including some that have smaller resolutions than those of the testing images. Additional strategies may be used for the multi-window training. For example, the training module 304 may upscale the training images. This may solve the problem in terms of resolution and positional embeddings, but may introduce a mismatch between train and test image local statics: images at training time are more blurry, and possibly with a different aspect ratio compared to test time. As another example, the training module 304 may insert a low resolution image (e.g., randomly) in a high resolution image, padded with zeros, and constrain the windows to only be in the region of the original input. This may solve the problem both in terms of input resolution and local statistics, but may introduce biases in the window distribution, as they may never be further apart than the original resolution and so the transformer module 312 may not learn full range dependencies. When lower-resolution images are used at training time, the training module 304 may choose (e.g., randomly) one of these two strategies, allowing to obtain i. a target resolution, ii. target local statistics and iii. full range dependencies.

Regarding binocular tasks, note that the transformer module 312 may perform self-attention on both images separately in a siamese manner and cross-attention between tokens of both images may be used. The computational complexity would scale in O((H₁×W₁)²)+O((H₂×W₂)²) for the encoders of the transformer module 312, while for the decoder the self-attention complexity would scale in O((H₁×W₁)²) and the cross-attention in O(H₁×W₁×H₂×W₂). Therefore, the windowing of both images may be used during the training.

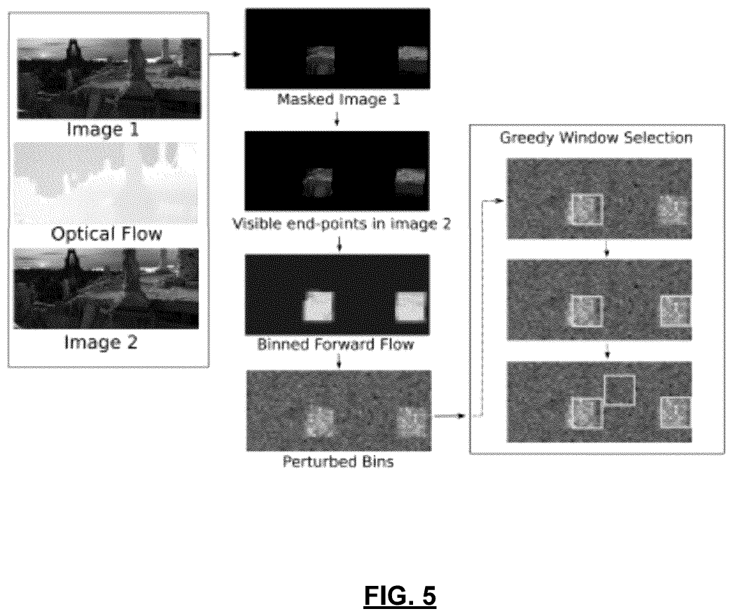

For training for binocular tasks, the training module 304 inputs pairs of training images, each with windows as described herein, to the transformer module 312 and trains the transformer module 312 based on the pairs. A pair of images may be taken at the same time by two different cameras or at different times (e.g., two different frames of video). Each pair includes at least some common content (e.g., pixels, objects, etc.). The pairs may have the same or different numbers of windows (N>=2 and M>=2 respectively). For example, a first image of a pair may include N=2 windows and a second image of that pair may include M=3 or M=4 windows. The training module 304 sets the windows of the second image to include the same features as included in the windows of the first image. Optical flow may involve finding dense correspondences between pixels in the image pairs. Simply masking both images randomly would lead to a very sparse training signal, as matching pixels would have a low chance of being visible in both inputs. In various implementations, the training module 304 may place the windows in the same location for both images of a pair. This would mean that matching pixels would be co-visible in both images only for small displacements. In various implementations, the training module 304 may displace the windows following the ground-truth flow to maximize the amount of co-visible tokens, but may give away most of the answer during training. Furthermore, flows from pixels of a window in the original image can go in different directions. In view of the above, the training module 304 may a) displace the windows in the second image following a noisy flow value and/or b) use more windows in the second image (than the first image), that can randomly act as distractors or account for multiple possible flow directions inside a single window. FIG. 5 includes an example illustration of the processing of two images of a pair (as shown in the first column of FIG. 5 as Image 1 and Image 2 with a given Optical Flow between the images), where the example task is to select three windows (M=3) in a second image that are used for training when two windows (N=2) in a first image (see first image in the second column of FIG. 5) are selected using the methods set forth herein. Portions of each image not included in a window are masked. The three windows in the second image are selected in this example task by: (a) computing visible end-points using the given Optical Flow (see second image in the second column of FIG. 5); (b) counting occurrences of visible pixels in the image tokens (see third image in the second column of FIG. 5); (c) perturbing the counting of (b) by adding noise (see fourth image in the second column of FIG. 5). The set of three windows (M=3) are sequentially selected, for example using a greedy algorithm (see the three images in the third column of FIG. 5). As discussed herein the third window selected (see the middle window in the third image in the third column of FIG. 5) acts as a distractor from the first two windows selected (see the left window in each image in the third column of FIG. 5 and the right window in the second and third image in the third column of FIG. 5) that contain the most relevant information from the selected windows in the first image.

Training may be, for example, 100 epochs or another suitable number of epochs. A fixed budget of approximately 1024 tokens may be used-up to rounding errors depending on resolutions-among the 3600 tokens in the full resolution input, with varying numbers of windows. One window performs significantly worse than N>=2 as long-range interaction cannot be taken into account. With N>=2, local interactions are modeled within a window while longer-range interactions are modeled across windows.

The addition of the temperature parameter of the softmax function also increases performance to account for the discrepancy of the number of tokens during training (e.g., approximately 1024) and testing (e.g., approximately 3600). The use of relative positional embeddings (as opposed to absolute positional embeddings) also increases performance. Absolute positional embeddings may suffer from interpolation from the low-resolution pre-trained models and to the absence of the translation equivariance.

In various implementations, N may be equal to 2. The size of each window may be set to approximately 1024 tokens or another suitable size. Each window may be rectangular, square, or have another suitable shape. One token may be generated per pixel or group of two or more pixels of each window. The windows do not overlap but may share all or a portion of an edge (e.g., the windows may touch). While the same size and shape may be used, the windows may be rotated (e.g., rectangle in portrait orientation and rectangle in landscape orientation). The multi window training described herein is robust to various window shapes and sizes.

The training images may include real images and/or synthetic images.

For binocular tasks, hyper-parameters control the way windows in the second image are placed in relation to that window in the first image and corresponding flow. The number of windows used in the first image is may be 2, and the number of windows used in the second image of each pair may be 2 to 5, keeping the total number of tokens visible approximately constant (e.g., approximately 200) by changing the window resolution. Experiments show that the performance improves significantly when going from 2 windows to 3, and using 3, 4, or 5 windows performs similarly. In various implementations, noise in the window selection may be set to approximately 0.3 for improving performance or another suitable value.

The number of tokens between training with multi-window and testing at full (higher) resolution may impact statistics of the self-attention operation. The larger set of tokens may lead to an increased divider in the softmax. The temperature in the softmax may generate a better attention map with similar behavior in the neighborhood of a selected token and better the self-probability, e.g., the weight for attending to itself. The training module 304 may set the temperature of the softmax of the transformer module 312 based on the training images, such as the training images without windows.

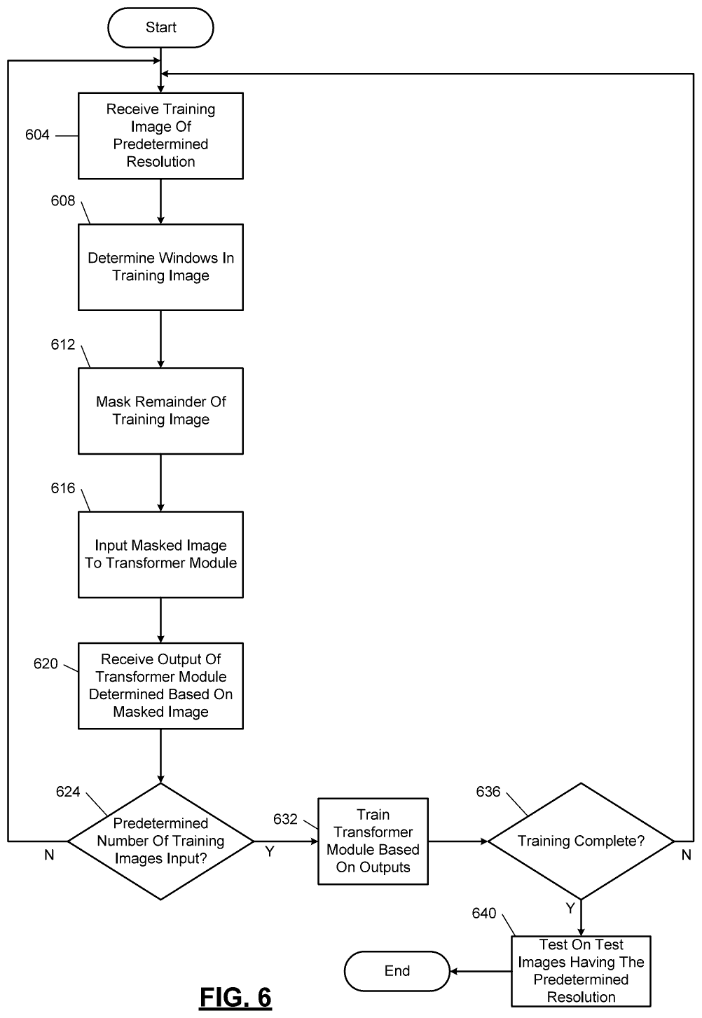

Referring now to FIG. 6, a flowchart depicting an example method of training and testing the transformer module 312. Control begins at 604 where the training module 304 receives a training image of a predetermined resolution. After training, the transformer module 312 is tested using testing images of the predetermined resolution.

At 608, the training module 304 determines N windows in the training image, such as randomly located. N is an integer greater than or equal to 2. At 612, the training module 304 masks the remainder of pixels the training image that are outside of the N windows. For the binocular example, the training module 304 receives a pair of training images, determines N windows in a first one of the pair of training images, and M windows in a second one of the pair of training images. M is an integer greater than or equal to N. The training module 304 determines the M windows in the second one of the pair of training images based on the pixels in the N windows (such that ones of the M windows include pixels of the same content as in the N windows).

At 616, the training module 304 inputs the masked image (images in the binocular example) to the transformer module 312. At 620, the transformer module 312 determines an output based on the input, and the training module 304 receives the output of the transformer determined based on the input image(s).

At 624, the training module 304 determines whether a predetermined number of training images have been input to and processed by the transformer module 312. The predetermined number is an integer greater than one and may be, for example, 500, 1,000, etc., If 624 is true, control may continue with 632. If 624 is false, control returns to 604.

At 632, the training module 304 trains one or more parameters of the transformer module 312 based on the outputs of the transformer module 312 (e.g., relative to expected outputs) generated based on the input training images. At 636, the training module 304 may determine whether training is complete. The training module 304 may determine that training is complete, for example, when a predetermined number of instances of 632 have been complete, when an accuracy of the transformer module 312 is greater than a predetermined accuracy, when an error of the transformer module 312 is less than a predetermined error, and/or when one or more ending conditions have been satisfied. If 636 is true, control may continue with 640. If 636 is false, control may return to 604. At 640, the training module 304 tests the transformer module 312 using testing images having the same predetermined resolution as the predetermined resolution of the training images. Testing may involve inputting test images of the predetermined resolution to the transformer module 312 and determining an accuracy of the transformer module 312 based on comparisons of outputs of the transformer module 312 relative to expected outputs, respectively, of the transformer module 312.

As an example of a vision task, the present application may be applied to the monocular task of depth estimation. A ConvNext prediction head may be used to determine the depth at each pixel. The ConvNext is described in Z. Liu, et al., A convnet for the 2020s, CVPR, 2022b, which is incorporated herein in its entirety.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A training system, comprising:
a transformer module having the transformer architecture and configured to perform a vision task; and
a training module configured to:
receive a training image having a predetermined resolution;
determine N windows of tokens of pixels in the training image and mask the tokens of all of the other pixels of the training image that are outside of the N windows,
where N is an integer greater than or equal to 2;
input the N windows of tokens to the transformer module;
train the transformer module based on an output of the transformer module generated based on the N windows of tokens; and
test the transformer module using a test image having the predetermined resolution.

2. The training system of claim 1 wherein the N windows are each a rectangle of pixels.

3. The training system of claim 2 wherein a first one of the N windows is oriented in a landscape orientation and a second one of the N windows is oriented in a portrait orientation.

4. The training system of claim 1 wherein the N windows are each a square of pixels.

5. The training system of claim 1 wherein the N windows are each the same size.

6. The training system of claim 1 wherein the N windows do not overlap.

7. The training system of claim 1 wherein at least a part of a first edge of a first one of the N windows abuts at least a part of a second edge of a second one of the N windows.

8. The training system of claim 1 wherein a first total number of pixels within the N windows is 5-50 percent of a second total number of pixels of the training image.

9. The training system of claim 1 wherein the training module is configured to determine locations for the N windows randomly.

10. The training system of claim 1 wherein the training module is further configured to:
receive a second training image having the predetermined resolution;
determine N second windows of tokens of pixels in the second training image and mask the tokens of all of the other pixels of the second training image that are outside of the N second windows;
input the second N windows of tokens to the transformer module; and
train the transformer module further based on a second output of the transformer module generated based on the N second windows of tokens.

11. The training system of claim 10 wherein first locations of the N windows are different than second locations of the N second windows.

12. The training system of claim 1 wherein the training module is configured to input the N windows to the transformer module with positional embeddings.

13. The training system of claim 12 wherein the positional embeddings are relative positional embeddings.

14. The training system of claim 1 wherein the vision task is one of a monocular vision task and a multiple-view vision task.

15. A training system, comprising:
a transformer module having the transformer architecture and configured to perform a vision task; and
a training module configured to:
receive first and second training images having a predetermined resolution;
determine N windows of tokens of pixels in the first training image and mask tokens of all of the other pixels of the first training image that are outside of the N windows,
where N is an integer greater than or equal to 2;
determine M windows of tokens of pixels in the second training image and mask tokens of all of the other pixels of the second training image that are outside of the M windows,
where M is an integer greater than or equal to 2;
input the N windows and the M windows to the transformer module;
train the transformer module based on an output of the transformer module generated based on the N windows and the M windows; and
test the transformer module using a pair of test images having the predetermined resolution.

16. The training system of claim 15 wherein M is greater than N.

17. The training system of claim 15 wherein the training module is configured to determine locations for the M windows based on locations of the N windows.

18. The training system of claim 15 wherein the first and second training images each include at least a portion of a same item.

19. The training system of claim 15 wherein the first and second training images are one of:
captured by first and second cameras, respectively, at approximately the same time; and
two frames of video captured by one camera at different times.

20. The training system of claim 15 wherein the training module is configured to select the second locations of the M second windows based on noisy optical flow.

21. The training system of claim 20 wherein the training module is configured to select the second locations of the M second windows using a greedy algorithm.

22. The training system of claim 15 wherein the training module is configured to displace the second locations of the M second windows in the second training image based on a noisy flow value.

23. The training system of claim 15 wherein M is greater than N to randomly act as distractors or account for multiple possible flow directions inside a single window.

24. The training system of claim 15 wherein the N windows are configured to reduce an effective overall resolution of the training image during training without compromising actual resolution of the training image.

25. A system, comprising:
a camera configured to record images;
a semantic segmentation module configured to segment objects in the images recorded by the camera;
at least one of (a) a propulsion device configured to move an object and (b) an actuator configured to actuate an object; and
a control module configured to, based on one or more of images recorded by the camera including the objects segmented in the one or more images segmented by the semantic segmentation module, control the at least one of the (a) propulsion device and (b) the actuator,
wherein the semantic segmentation module includes a transformer module having the transformer architecture and configured to perform a vision task; and
wherein the transformer module is trained by a training module configured to:
receive a training image having a predetermined resolution;
determine N windows of tokens of pixels in the training image and mask the tokens of all of the other pixels of the training image that are outside of the N windows,
where N is an integer greater than or equal to 2;
input the N windows of tokens to the transformer module;
train the transformer module based on an output of the transformer module generated based on the N windows of tokens; and
test the transformer module using a test image having the predetermined resolution.
